(19) United States
(12) Patent Application Publication
(10) Pub. No.: US 2008/0294497 A1
(43) Pub. Date: Nov. 27, 2008

(54) Feedback-driven ad targeting

(75) Inventors: Geoffrey Simons, Seattle, WA (US); Nathaniel McNamara, Miami Beach, FL (US)

Correspondence Address: PATENT DOCKET ADMINISTRATOR;LOWENSTEIN SANDLER PC, 65 LIVINGSTON AVENUE, ROSELAND, NJ, 07068, US

(73) Assignee: Chintano, Inc.

(21) Appl. No.: 11/805,241

(22) Filed: May 22, 2007

(51) Int. Cl. G06Q 30/00; G06F 17/30

(52) U.S. Cl. 705/10

(57) ABSTRACT

Methods and systems for selecting and serving an ad to a Web page in response to an ad request from that page, where the ad being delivered has the highest or close to the highest expected value, are described. The prior history of an ad is examined and the circumstances relating to the ad that have led to a positive action for the ad in the past (such as a click on the ad by a user) are determined. This data are collected and stored in a first set of data. In addition, the characteristics of the ad request are examined. A likelihood function is used to derive a likelihood value which can be used to lead to a probability that the ad will be successful or have a positive result. Following this process, a group of Web pages is created that have shown a positive result when the ad was displayed. The creation of the group of Web pages results from executing one or more custom targeting engines. In addition, a group of ad requests for the ad that provided a positive result for the ad and another group of ad requests that did not provide a positive result for the ad are created. An ad is selected and served to the Web page based on a comparison of the ad request with these two groups of ad requests.

### BACKGROUND OF THE INVENTION

1. Field of the Invention

The present invention relates to online advertising systems. More specifically, it relates to software for effective online ad targeting based on the performance of ad requests and user profile data.

2. Description of the Related Art

Present ad targeting systems may use one of numerous systems. One of them is rule-based targeting, also referred to as pre-defined targeting, in that the conditions in which ads are shown are based on concrete or specific values of a few variables. For example, one condition may be “if a user is a 25-year old male, show ad A, but if the user is a 40-year old woman, show ad B.” This system operates on the presumption that the advertiser or ad targeter “knows” which ads to display or serve given a set of conditions. Over time, certain patterns emerge based on the performance of the ads that have been served to a given group of users. However, once more variables are put into consideration, the process becomes more time consuming. Also, the process requires human input and maintenance.

Another system is known as clustering. The primary concept behind this system is clustering or grouping of all instances, where an instance, in this case, is a request for an ad and all the variables that are associated with the request. Once the instances are clustered, ads compete with other ads within each cluster to determine the best ad(s) to be served. Ads compete according to their calculated expected value of being served or displayed based on feedback into the system, the feedback consisting of clicks, conversions, impressions, and the like. The primary drawback of clustering is that, as noted, the clusters that form may have little or no differentiation in terms of which ads are effective. Clustering is effective at breaking up users (i.e., ad viewers) into different segments, however, additional work is needed to potentially merge two or more segments, or conversely, divide a segment into two or more sub-segments.

Therefore it would be desirable to have an advertising targeting system that is efficient at determining the probability that an ad that is served is accurate and efficient.

### SUMMARY OF THE INVENTION

In one aspect of the invention, methods of selecting and serving an ad to a Web page in response to an ad request from that page, where the ad being delivered has the highest or close to the highest expected value, are described. The prior history of an ad is examined and the circumstances relating to the ad that have led to a positive action for the ad in the past (such as a click on the ad by a user) are determined. This data are collected and stored in a first set of data. In addition, the characteristics of the ad request are examined. A likelihood function is used to derive a likelihood value which can be used to lead to a probability that the ad will be successful or have a positive result. Following this process, a group of Web pages is created that have shown a positive result when the ad was displayed. The creation of the group of Web pages results from executing one or more custom targeting engines. In addition, a group of ad requests for the ad that provided a positive result for the ad and another group of ad requests that did not provide a positive result for the ad are created. An ad is selected and served to the Web page based on a comparison of the ad request with these two groups of ad requests.

In other aspects of the present invention, one or more attributes of an ad request that are most relevant to the ad are determined. It is also determined whether the attributes are indicative or are neutral. In another embodiment of the present invention, a “click probability” and an expectation value of an ad are calculated. In another embodiment, another group of Web pages is created, wherein the pages have not shown a positive result when the ad has been displayed. The creation of the Web pages is performed by execution of one or more custom targeting engines.

### BRIEF DESCRIPTION OF THE DRAWINGS

References are made to the accompanying drawings, which form a part of the description and in which are shown, by way of illustration, specific embodiments of the present invention:

FIG. 1 is a flow diagram of one illustrative process of selecting and serving an ad in the feedback-driven ad targeting system in accordance with one embodiment of the present invention.

### DETAILED DESCRIPTION OF THE INVENTION

Example embodiments of an online advertising system and method according to the present invention are described. These examples and embodiments are provided solely to add context and aid in the understanding of the invention. Thus, it will be apparent to one skilled in the art that the present invention may be practiced without some or all of the specific details described herein. In other instances, well-known concepts and online advertising concepts, components and technologies have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

Methods and systems for finding an ad with the highest expected value for a given ad request are described. The described embodiment of the present invention is a feedback-driven system for determining whether an ad that is served to a Web page is likely to result in a positive action, such as a click. The system determines the circumstances that have led to a positive action in the past for a particular ad. In the described embodiment, the system collects data on which ad requests resulted in a positive step (e.g., a click on the ad) and which ones did not for a particular ad. Thus, by examining characteristics of an ad request, such as the attributes of a Web page, the system can compare these characteristics to attributes of Web pages to which the ad in question had previously been served and other attributes (Web page attributes can be described as a subset of all possible attributes that may be considered), such as user attributes and have resulted in a positive action. In this manner, a likelihood value for an ad can be derived. In another embodiment, the attributes, including attributes of Web pages, in which the ad was served but did not result in a positive action, in other words, resulted in a non-action, are also examined to further enhance the probability that an ad served in response to a request has a higher value or is more likely to be clicked on. The systems and methods of the present invention examine the prior history of an ad with respect to Web pages in which the ad has been shown among other factors and determines probabilities of how effective the ad will be in future ad requests.

The ad targeting system of the present invention uses a set of custom engines running in real time that determine (1) the probability that a given Web page will perform well for a given ad, (2) the probability that a given user will react to a given ad, and (3) the probability that a given ad or cluster of ads would perform well with a given cluster of pages and/or users. In one embodiment, the custom engines can run in parallel for greater optimization to handle the computational load.

Given a single ad campaign, the goal of the ad targeting system of the present invention is to group together all the pages that have demonstrated positive results (in a statistically significant sample size) in order to enable a core Bayesian classification engine of the present invention to identify other pages similar to that group in close to real time or “on the fly.” A specific example may be an ad from a travel company, where the core engines of the present invention create an implied topic called “Pages that work for Travel Company.” The Bayesian engine of the present invention is trained with a binary training set comprised of (1) pages where that Travel Company ad was clicked and (2) pages where it was not. No other training set or ontology would need to be designed or implemented, enabling mass customization of targeting with maximum efficiency.

In addition, a stored text file could be used (in combination with last-changed date stamps, checksums, etc.) to determine whether a new page is really new or simply a copy of previously identified (and classified) text. The present invention may process new content on a near real time basis, running tokens for that content through hundreds or thousands of Bayesian classification engines in parallel. This is possible because the information needed to calculate expected values for each ad may be partitioned across as many servers as there are ads. In one embodiment, the partitioned processing servers would just build up a summary targeting model which would be forwarded to the actual targeting engines.

For the purposes of describing the present invention, terms and phrases used to illustrate concepts are described below. An “instance” may be a set of features relating to a single object that is to be analyzed, where an object is a single copy of an abstract concept embodying both data and the methods to interact with that data. An instance may also be described as “attribute-value” pairs, for example, an attribute may be the gender of the user making the request and a value is male.

An attribute may be described as a single feature of an instance. It may be defined as a name and type of data of a feature of an instance. In general, an attribute may be numerical, Boolean, nominal (multiple choice), or textual.

In the described embodiment, the following description of terms may apply. For example, a Similarity Function is a function that computes the similarity between two instances, or between an instance and a cluster of instances, or between two clusters of instances. A Complex Similarity Functions may be required to compute similarity based on any type of Attributes of Instances. A Cluster, in one embodiment, is a collection of instances, generally derived through the use of grouping together the instances according to a similarity function and a given clustering algorithm. An Ad Targeting System is a system that returns an Ad Impression given an Ad Request. An Ad Request may be an instance of concern for Ad targeting problems and the input to an Ad Targeting System. An Ad Impression may be the output of an Ad Targeting System and may also be used as feedback to Ad Targeting Systems. An Ad Click may be a click on an Ad viewed by the user. The result of the click is that the user is shown the advertiser's landing page. An Ad Conversion is a conversion that usually refers to a secondary action after the user reaches the advertiser's landing page. This may include a purchase, sign-up, or some other type of user action which the advertiser values in some way. A Positive Result may be any action taken by the user which has a positive value. In general, this will either be a click or a conversion.

In addition, the following abbreviations may be used in the following description of the present invention:

CPM—Cost per 1000 impressions.
CPA—Cost per action.
CPC—Cost per click.
CTR—Click-thru rate.

In one embodiment, the feedback-based ad system of the present invention functions by building two groups for an ad X, each group defined, in part, as “Ad requests that yielded positive results for X” and “Ad requests that did not yield a positive result for X”. Subsequent ad requests are compared with both groups for each ad in a cluster to determine which ad has maximal value for the given ad request. In the described embodiment, value more likely will relate to probability of being selected. Thus, the highest valued ad will have the highest change of being shown, but is proportional to the ad's value.

In the present invention, the ad targeting method and system is able to efficiently determine which Attributes of Ad Requests are the most relevant with respect to a given Ad. To further illustrate, two Attributes of an Ad Request are provided: age and gender of the user making the request. The following historical data are available for an Ad.

Ad Requests resulting in a click (i.e., a viewer responding to an ad by “clicking” on it):
AdReq 1: clicked on by a male, 25
AdReq 2: clicked on by a female, 25
AdReq 3: clicked on by a male, 24
AdReq 4: clicked on by a female, 26
Ad Requests not resulting in a click:
AdReq 5: not clicked on by a male, 40
AdReq 6: not clicked on by a female, 35
AdReq 7: not clicked on by a male, 45
AdReq 8: not clicked on by a female, 32

In this example there are eight Ad Requests. It is clear that gender is a non-indicative attribute in determining if an ad is likely to be clicked on by the viewer (two ad requests were clicked on by a male and two were not; the same for ad requests and females). In contrast, age, another attribute, is indicative in determining if an ad is likely to be clicked on by the viewer. Viewers aged 24 to 26 clicked on the ad, and viewers aged 32 to 45 did not click the ad. In the example above, gender is considered a neutral attribute or feature, while age is an indicative attribute/feature.

If conventional, clustering had been used in the above illustration, for example with four clusters:

### Cluster 1: Males, Aged 20-30

### Cluster 2: Males, Aged 31-45

### Cluster 3: Females, Aged 20-30

### Cluster 4: Females, Aged 31-45,

assuming the same Ad Requests were issued, there would be two impressions in each cluster. Clusters 1 and 3 would have a strong bias towards showing the ad in question, while Clusters 2 and 4 would not. With conventional clustering these are four clusters instead of two with the present invention. However, it may be noted that Clusters 1 to 4 will each have a set of ads.

Taking the conventional clustering illustration further, suppose that there are 20 attributes/features per Ad Request (as opposed to two: gender and age) and that there are 1000 ads (instead of only one) from which to choose from for a given Ad Request. Assume also that in the conventional cluster example, multivariate clustering is used to create 50 clusters (rather than only four). Multivariate clustering is clustering of instances which contain multiple variables.

Therefore, there are 50,000 cluster-ad combinations for which data may be tracked and maintained. However, in one embodiment of the present invention, there are only 2,000 clusters, two for each of the one thousand ads. If only two “user segment” clusters were created, wherein a user segment cluster is a group of users who are similar as defined by the similarity function associated with the segment. A user segment cluster may also be pre-defined without using any actual clustering. These are referred to as rule-based user segment clusters. There may be many data points in the present feedback-driven ad targeting system. One of the drawbacks with conventional clustering is that an ad serving entity may often accumulate only sparse amounts of useful data to make statistically significant targeting choices. With the present invention, the data are more complete, allowing for more accurate calculations.

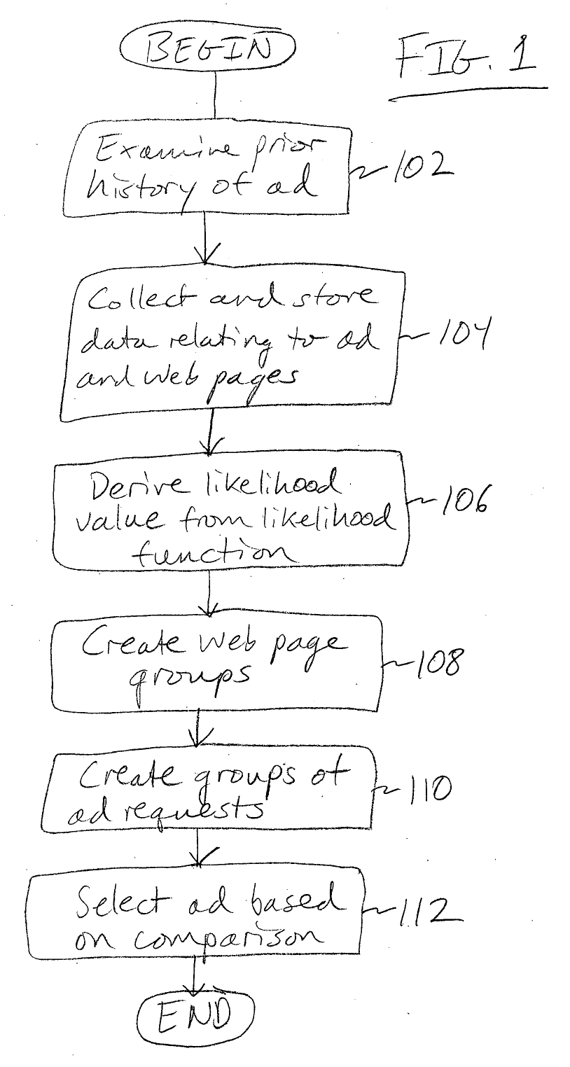

FIG. 1 is a flow diagram of one illustrative process of selecting and serving an ad in the feedback-driven ad targeting system in accordance with one embodiment of the present invention. The order of the steps in FIG. 1 is purely illustrative and describes one embodiment. The order of the steps may be different, may occur concurrently, or may overlap one another without changing the scope of the present invention. At step 102 the prior history of an ad is examined and the circumstances relating to the ad that have led to positive actions for the ad, such as a click or conversion, in the past are determined. For example, all the Web pages in which the ad has appeared or in which similar ads have appeared (e.g., all ads from a specific travel agency) and have resulted in a user clicking on the ad are examined. Similarly, Web pages in which the ad or similar ads have appeared and have not resulted in a positive action are examined. At step 104 the data from the examination are collected and stored for an ad or a group of ads. This can be done at one of numerous locations, including servers of the ad service provider or similar online ad serving entity. At step 106 a likelihood value is derived using a likelihood function. In one embodiment, the likelihood value may be used to calculate a probability that the ad will be successful on a particular Web page. At step 108 a group of Web pages is created, the group containing only pages that have resulted in a positive action from a user. In one embodiment, another group of Web pages is created containing only pages that have resulted in a negative or non-action by a user. In one embodiment, these Web page groups are created by one or more custom targeting engines. In another embodiment, these engines are Bayesian Inference engines, as described in further below. At step 110 a group of ad requests for an ad that provided a positive result for the ad and another group of requests that did not provide a positive result are created. These groups may also be created using the custom targeting engines. At step 112 an ad is selected and served to a Web page based on a comparison of the ad request with the two groups of ad requests created at step 110.

### Bayesian Inference Implementation:

In one embodiment of the present invention, a Bayesian Inference implementation is used. The system can be described as an “expectation maximization” algorithm. In the field of Internet advertising, the first significant action is a click by a viewer on an online ad. In some cases the click itself has a concrete value, as in CPC advertising, while in other cases, the click has an expected value, as in CPA advertising. One goal of the present ad targeting system is to predict as accurately as possible the “click probability” of all available ads. This would enable the calculation of “expectations” for each of the available ads.

EV(Adⱼ|Request)=P(Clickⱼ|Request)*Value(Clickⱼ)

In the described embodiment, the Ad most likely to be shown will be the one with maximal EV.

For pay-per-click advertising rates,

Value(Clickⱼ)=CPCⱼ,

where CPCⱼ is the monetary or other value paid for a click on Adⱼ
For pay-per-action advertising,

Value(Clickⱼ)=CPA_{J}*P(Conversionⱼ|Clickⱼ),

where CPAⱼ is the price paid per Conversion on Adⱼ
The present invention is efficient at accurately Calculating P(Clickⱼ|Request).

In the present invention, for a given Adⱼ, there are two sets of Ad Requests. One set of Ad Requests contains ads which resulted in a click (or more generally a positive action), and one set of Ad Requests which did not lead to a click (a negative action).

When a new Request is received by the custom targeting engine of the present invention, it is compared with the two sets of Requests (positive and negative) for each Adⱼ in order to calculate the probabilities that each Ad will be clicked on. Combined with the value of the click as described above, the ad with maximal expectation is selected. In another embodiment, an ad is selected from a distribution of ads weighted by expected value.

In the described embodiment, with Bayesian Inference the probability of a click on Adⱼ given Request, can be expressed as:

P(Clickⱼ|Request)=P(Clickⱼ)*P(Request|Clickⱼ)/P(Request)

P(Clickⱼ) is the prior probability of a click on Adⱼ based on evidence seen before Request.
P(Request|Clickⱼ) is the conditional probability of seeing Request on previous clicks.
P(Request) is the marginal probability of seeing Request regardless of whether or not a click occurred.
P(Clickⱼ)=n(clicks on Adⱼ)/n(reqs Adⱼ has been shown to)

For Bayesian Inference, and more specifically, a Naïve Bayes Classifier, it is assumed that all the features of Request contribute independently towards the overall probability, thus eliminating the need for complex joint probabilities between different features. In practical approaches, this may not always be a completely valid assumption to make, but may save computation time and still yield very accurate results. Therefore, the probability of a Request given Clickⱼ can be expressed as the product of probabilities of each feature rᵢ equaling Request's value Requestᵢ given Clickⱼ.

$$P ( Request \vert Click ) = {\prod }_{i} P ( {r}_{i} = {Request}_{i} \vert {Click}_{j} )$$

As mentioned earlier, there are different types of features. For numerical features, the features are discretized in order to best calculate probabilities. Furthermore, unless the values are discretized, calculating any kind of probabilities becomes an inefficiently long process.

For example, one parameter or feature can be the age of a user who is making the request.

P(age=age of Request|Clickⱼ)=n(age=age of Request)/n(Requests of any age)

However, it is possible to expand the range of a given feature's influence. Continuing with the age example, it is logical to assume that users aged 23 would respond similarly to users aged 24. So it could be helpful to include them when computing the probability that a request relates to a click. In this case, a similarity function could be used such that:

$$Sim ( age , age of Request ) = 1$$

$$0 < Sim ( age , age != age of Request ) < 1$$

$$and$$

$$P ( age = age of Request \vert {Click}_{j} ) = \frac{{\sum }_{x = {age}_{min}}^{x = {age}_{max}} Sim ( age of Request , x ) * n ( age of Request = x )}{n ( Request of any age )}$$

In one embodiment, it may be useful to examine likelihood functions as a means to filter out noisy features. For instance, there may be an Ad for which 90% of the people clicking on the Ad are men. However, this information is of limited value if 90% of non-clickers were also men. Likelihood functions are a useful way to weight features according to how much they differentiate clickers from non-clickers. In the described embodiment, the likelihood function is the ratio of probabilities between a click given a specific request and a non-click given the same request.

It becomes more difficult to calculate an actual predicted value for showing the Ad since the likelihood of a click is only proportional to the actual probability of a click. Regardless, the probability of a click is proportional to the likelihood function, so is useful in determining the ad with maximal value. One advantage to using a likelihood ratio instead of probabilities is that the denominators on the probabilities cancel out, since P(Request) is calculated over all possible outcomes, in the described embodiment two outcomes, a click or no click.

Another method of reducing the influence of noisy features is to weight them down. For example, for a given Adⱼ the gender distribution for Clickers is 60% male/40% female. And the gender distribution for non-Clickers is 65% male/35% female. In this case, it is fair to say that gender does not play a large role in determining P(Click|Request). Furthermore, if only the gender distribution of Clickers is in consideration, if the Request came from a male, that would likely boost the click probability, even though the fact that the Request came from a male makes it even more likely that a click will not occur. In the likelihood function case, the factors would even out to close to one (e.g., 0.923).

In one embodiment of a Likelihood Function:

$$Λ ( {Click}_{j} \vert Request ) = \frac{P ( {Click}_{j} \vert Request )}{P ( Not a {Click}_{j} \vert Request )}$$

$$Λ ( {Click}_{j} \vert Request ) = \frac{P ( {Click}_{j} )}{P ( Not a {Click}_{j} )} * \frac{P ( Request \vert {Click}_{j} )}{P ( Request \vert Not a {Click}_{j} )}$$

$$Λ ( {Click}_{j} \vert Request ) = \frac{n ( {Click}_{j} )}{n ( Not a {Click}_{j} )} * \frac{\prod P ( {r}_{i} = {Request}_{i} \vert {Click}_{j} )}{\prod P ( {r}_{i} = {Request}_{i} \vert Not a {Click}_{j} )}$$

$$The probability of a click on {Ad}_{j} , given Request has feature i ( {Request}_{i} ) value equal to {r}_{i} , is \text{:}$$

$$P ( {r}_{i} = {Request}_{i} \vert {Click}_{j} ) = \frac{n ( {r}_{i} = {Request}_{i} \vert {Click}_{j} )}{n ( {r}_{i} \vert {Click}_{j} )}$$

$$Λ ( {Click}_{j} \vert Request ) = \frac{n ( {Click}_{j} )}{n ( Not a {Click}_{j} )} * \frac{\prod n ( {r}_{i} = {Request}_{i} \vert {Click}_{j} ) / n ( {r}_{i} \vert {Click}_{j} )}{\prod n ( {r}_{i} = {Request}_{i} \vert Not a {Click}_{j} ) / n ( {r}_{i} \vert Not a {Click}_{j} )}$$

One assumption that can be made is that the number of clicks on Adⱼ given all values of a feature i will be equal to the number of clicks on Adⱼ. This is because of the assumption that all instances of data (the Ad Requests) will have values for each feature. Furthermore an unknown value can be created for any instance which is lacking a valid value for any feature. In this case (assuming m features):

n(r₀|Clickⱼ)=n(r₁|Clickⱼ)= . . . =n(rₘ|Clickⱼ)=n(Clickⱼ)

thus,

n(rᵢ|Clickⱼ)=n(Clickⱼ) and n(rᵢ|Not a Clickⱼ)=n(Not a Clickⱼ)

Therefore, the likelihood function reduces to:

$$Λ ( {Click}_{j} \vert Request ) = {\prod }_{i} \frac{n ( {r}_{i} = {Request}_{i} \vert {Click}_{j} )}{n ( {r}_{i} = {Request}_{i} \vert Not a {Click}_{j} )}$$

$$If the feature ' s values are not mutually exclusive , as discussed above for age , there is \text{:}$$

$$P ( {r}_{i} = {Request}_{i} \vert {Click}_{j} ) = \frac{{\sum }_{x = {r}_{i \text{-} min}}^{x = {r}_{i \text{-} max}} Sim ( {Request}_{i} , x ) * n ( {r}_{i} = x )}{n ( {r}_{i} \vert {Click}_{j} )}$$

$$Following the same steps as for mutually exclusive values , the likelihood function reduces to \text{:}$$

$$Λ ( {Click}_{j} \vert Request ) = {\prod }_{i} \frac{{\sum }_{x = {r}_{i \text{-} min}}^{x = {r}_{i \text{-} max}} Sim ( {Request}_{i} , x ) * n ( {r}_{i} = x \vert {Click}_{j} )}{{\sum }_{x = {r}_{i \text{-} min}}^{x = {r}_{i \text{-} max}} Sim ( {Request}_{i} , x ) * n ( {r}_{i} = x \vert Not a {Click}_{j} )}$$

In an alternative embodiment, new ads that do not have a history, a default value is assigned to the ad that may be sufficiently high to compete with the other ads. In another embodiment, the inferences made in the ad-centric described embodiment of the present invention are reduced to a system that is able to effectively operate in real time. In another embodiment, any over fitting issues of the ad system of the present invention may be addressed by involving small randomizations in order to assure that the optimal conditions are found for each ad. In addition rigorous checks may be routinely performed by N-Fold cross validation to verify that the optimal clusters form for each ad.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

We claim:

1. A method of selecting an ad in response to an ad request, the ad having the highest expected value, the method comprising:
examining prior history of the ad and determining circumstances relating to the ad that have led to a positive action for the ad in the past;
collecting and storing a first set of data related to the circumstances;
examining characteristics of an ad request;
deriving a likelihood value using a likelihood function, the likelihood value leading to a probability that the ad will be successful;
creating a first group of Web pages that have shown a positive result when the ad has been displayed by executing one or more custom targeting engines;
creating a first group of ad requests for the ad provided a positive result for the ad and a second group of ad requests that did not provide a positive result for the ad; and
selecting the ad based on a comparison of the ad request with the third group and the fourth group.

2. A method as recited in claim 1 further comprising:
determining one or more attributes of the ad request that are most relevant to the ad.

3. A method as recited in claim 2 further comprising:
determining whether the one or more of the attributes of are indicative neutral.

4. A method as recited in claim 1 further comprising:
calculating a “click probability” of the ad; and
calculating an expectation of the ad.

5. A method as recited in claim 1 further comprising:
creating a second group of Web pages that have not shown a positive result when the ad has been displayed by executing the one or more custom targeting engines.
